(19) United States
(12) Patent Application Publication
(10) Pub. No.: US 2004/0176501 A1
(43) Pub. Date: Sep. 9, 2004

(54) Water-hodling material for soil

(76) Inventors: Hideki Yasuda, Tokyo (JP); Fumihiko Naitou, Tokyo (JP); Megumu Yuyama, Tokyo (JP); Norio Nagai, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/480,637

(22) PCT Filed: Jun. 25, 2002
(86) PCT No.: PCT/JP02/06328

(30) Foreign Application Priority Data
Jun. 27, 2001 (JP) 2001-194690
Jun. 11, 2002 (JP) 2002-169997

(51) Int. Cl. C08L 63/00

(52) U.S. Cl. 523/402

(57) ABSTRACT

A water-holding material for soil obtained by curing a composition comprising (a) a hydrophilic epoxy resin having at least two epoxy resin groups per one molecule and (b) an amine compound having at least two primary or secondary amino groups per one molecule as indispensable components.

### FIELD OF ART

The present invention relates to a novel application field of an epoxy resin and, specifically, to a water-holding material for soil.

### BACKGROUND OF THE INVENTION

At present, an epoxy resin has been used widely in the fields including electricity, coating, building and adhesiveness, utilizing its properties which are excellent in electrical properties, adhesion, heat resistance and chemical resistance.

Recently, acrylic resin type polymers with water-absorbing-water-holding functions such as a hydrolyzate of acrylonitrile copolymer or acrylamide copolymer, acrylic acid salt-acrylic ester copolymer or a saponified product of vinyl acetate-acrylic ester copolymer and a neutralized product of starch and acrylic acid graft polymer have been suggested and have been practically used in the fields including goods for sanitation, engineering works, agriculture and gardening (Japanese Patent Kokai (Laid-Open) No. 3-149288).

However, no epoxy resin type water-holding material for soil with water-absorbing-water-holding functions has been suggested.

An acrylic resin type water-holding polymer which has been used at present has been developed in order to increase water absorbing ability, and it sometimes exerts a harmful influence depending on fields to be used because it has a water absorbing ability of 100 to 1000 times its own weight. For example, when it was used as water-holding material for soil for agriculture and gardening, root decay of plants occurred with increase of water-holding quantity and, with its decrease, water-discharge ability lowered and further, even water unnecessary for plant was absorbed. Thus, root cut and a generally known stepchild phenomenon of a soil (a shapeless solid state of a soil) during mixing of a soil to be caused due to water absorbing of the polymer and the unbalance of water-holding quantity and water-discharge quantity easily occurred and some cases which dose not contribute to growth of a plant were confirmed. Thus, further improvement was necessary.

### DISCLOSURE OF THE INVENTION

An object of the present invention is to solve the above mentioned problems and to provide a water-holding material for soil with water-holding ability of about 2 to 50 times its own weight, excellent in a balance of water-holding ability and water-discharge ability.

The inventors have found that an epoxy resin cured product obtained by curing a composition comprising specific epoxy resin and specific amine compound as indispensable components and a water-containing epoxy resin cured product obtained by mixing the above-mentioned composition and water are excellent in a balance of water-holding ability and water-discharge ability and are the most suitable to agriculture and gardening, and have accomplished the present invention.

That is, the present invention provides a water-holding material for soil obtained by curing a composition comprising (a) a hydrophilic epoxy resin having at least two epoxy resin groups per one molecule, (b) an amine compound having at least two primary or secondary amino groups per one molecule as indispensable components, a water-holding material for soil obtained by mixing the above-mentioned composition and (c) water or (d) an aqueous solution and performing cure in a water-containing state, a water-holding material for soil obtained by further adding (cc) water or (dd) an aqueous solution to the above-mentioned water-holding material for soil and a water-holding material for soil obtained by mixing the above-mentioned water-holding material for soil and (e) a soil.

The present invention will be described in detail below.

The (a) epoxy resin to be used in the present invention is not limited so long as it is a hydrophilic compound having at least two epoxy groups per one molecule.

Examples thereof include polyether type epoxy resins to be obtained by reaction of ethylene glycol, diethylene glycol, polyethylene glycol, propylene glycol, dipropylene glycol, polypropylene glycol, polyethylene polypropylene glycol, etc., and epichlorohydrin; polyhydric alcohol type epoxy resins to be obtained by reaction of glycerin, polyglycerol, trimethylol propane, sorbitol, etc., and epichlorohydrin and one species thereof or a mixture of at least two species thereof also can be properly used.

Preferable examples include polyether type epoxy resins and polyhydric alcohol type epoxy resins, among which polyethyleneglycol diglycidyl ether, polypropyleneglycol diglycidyl ether, glycerol polyglycidyl ether, polyglycerol polyglycidyl ether and a mixture thereof are more preferable.

The epoxy equivalent of the epoxy resin to be used is preferably in the range of 130 to 1500 g/eq and more preferably in the range of 200 to 1000 g/eq.

It is possible also to use (a) an epoxy resin to be used in the present invention together with other epoxy resin(s) in the range not to imp air intended characteristics. They are well known and are not limited so long as they are conventionally used. Examples thereof include non-hydrophilic polyhydric alcohol type epoxy resins, bisphenol A type epoxy resins, bisphenol F type epoxy resins, phenolnovolac type epoxy resins, cresolnovolac type epoxy resins, bisphenol A novolac type epoxy resins, alicyclic epoxy resins, glycidylamine type epoxy resins, glycidylester type epoxy resins and phenyl glycidyl ether.

The (b) amine compound to be used in the present invention is not limited so long as it is a compound having at least two primary or secondary amino groups per one molecule.

Examples thereof include aliphatic primary amines such as ethylenediamine, polyethylenediamine, polyetherdiamine, diethylenetriamine, triethylene-tetramine, tetraethylenepentamine and xylylenediamine; alicyclic primary amines such as bisaminomethyl cyclohexane and isophorone diamine; aromatic primary amines such as metaphenylene diamine and diaminodiphenylemethane; aliphatic secondary amines such as each ethyleneoxide adduct of ethylenediamine, polyethylenediamine, polyetherdiamine, diethylenetriamine, triethylenetetramine, tetraethylenepentamine and xylylenediamine; alicyclic secondary amines such as each ethyleneoxide adduct of bisaminomethyl cyclohexane and isophoronediamine; piperazine and dicyandiamide and one species thereof or a mixture of at least two species thereof also can be properly used.

Preferable examples thereof include aliphatic primary amines and alicyclic primary amines, among which polyethylenediamine, polyetherdiamine, xylylendiamine, bisaminomethyl cyclohexane and isophoronediamine are more preferable.

Regarding the proportion of (b) an amine compound to (a) an epoxy resin, an equivalent ratio (active hydrogen equivalent/epoxy equivalent) of hydrogen atom directly bonded to nitrogen atom of (b) an amine compound to epoxy group of (a) an epoxy resin is preferably in the range of 0.3/1 to 3/1 and more preferably in the range of 0.6/1 to 2/1.

It is possible also to use (b) an amine compound to be used in the present invention together with other amine compound(s) in the range not to impair intended characteristics. They are well known and are not limited so long as they are conventionally used.

Examples thereof include primary monoamines such as benzylamine and secondary monoamines such as piperidine.

In the present invention, in order to adjust a cure rate of the composition comprising (a) an epoxy resin and (b) an amine compound as indispensable components, it is possible also to add a cure promoter.

They are well known and are not limited so long as they are conventionally used. Examples thereof include tertiary amines, imidazoles and derivatives thereof.

In the present invention, it is possible also to use the composition comprising (a) an epoxy resin and (b) an amine compound as indispensable components together with a known water-holding high molecular weight substances in the range of not to impair intended characteristics.

The water-holding high molecular weight substances are not limited so long as they are convention ally used.

Examples thereof include starch, polyalkylene oxide, polyacrylamide and sodium polyacrylate.

Further, it is possible also to add well known additives such as antioxidant, ultraviolet absorbent, fluorescent sensitizer, dye and pigment to the composition comprising (a) an epoxy resin and (b) an amine compound as indispensable components.

The composition comprising (a) an epoxy resin and (b) an amine compound as indispensable components of the present invention is treated at 0 to 150° C. for 1 to 48 hours and preferably at 40 to 120° C. for 2 to 10 hours to cure, whereby a water-holding material for soil comprising a resin cured product is obtained.

In the present invention, it is preferable to mix the composition comprising (a) an epoxy resin and (b) an amine compound as indispensable components with (c) water or (d) an aqueous solution and perform cure in a water-containing state.

Generally, the reaction of (a) an epoxy resin and (b) an amine compound often proceeds with rapid exothermic even at a room temperature and it is difficult to control the reaction. On the other hand, when the composition comprising (a) an epoxy resin and (b) an amine compound as indispensable components is mixed with (c) water or (d) an aqueous solution, it becomes easy to control the reaction and (c) water or (d) an aqueous solution mixed in the above-mentioned composition is taken in a gelled product at the time when gelation is attained after progression of the curing reaction to reach cure in a water-containing state. Thereby, it becomes possible to obtain readily a water-containing resin cured product and workability is improved.

The (c) water as a preferable mode of the present invention is not limited so long as it is conventionally used. Examples thereof include industrial water, city water, well water, ion-exchanged water and pure water.

The (d) aqueous solution as a preferable mode of the present invention is not limited so long as it is a well known substance to be conventionally used as a function-providing agent for soil which is dissolved or suspended in the above-mentioned (c) water. Examples thereof include aqueous solutions containing manure components including water-soluble nitrogen compounds such as urea, water-soluble phosphorous compounds such as potassium hydrogen phosphate and water-soluble potassium compounds such as potassium chloride, a plant activator and a decay resisting agent.

The concentration of (d) an aqueous solution is preferably 0.01 to 5% by weight and more preferably 0.05 to 2% by weight.

The temperature for mixing (c) water or (d) an aqueous solution in the above-mentioned composition is not limited. It is preferable that it is usually about 30 to 80° C. The amount of (c) water or (d) an aqueous solution to be mixed is preferably 1 to 500 parts by weight and more preferably 20 to 300 parts by weight per 100 parts by weight of the above-mentioned composition.

When the above-mentioned composition is mixed with (c) water or (d) an aqueous solution to perform cure in a water-containing state, the curing conditions are 5 to 95° C. and 2 to 48 hours and preferably 40 to 80° C. and 3 to 24 hours. Thereby, a water-holding material for soil comprising a water-containing resin cured product is obtained.

If necessary, pulverization of the resin cured product or the water-containing resin cured product of the present invention is carried out. Here, in order to remove factors to impair an appearance of the polymer and water-absorbing-water-discharge characteristics of the polymer such as adhesion of pulverized powder or non-uniformity of pulverization to be caused during pulverizing and cloud of gloss to be caused during curing, it is preferable to perform washing treatment with water.

The temperature of water to be use d for washing is preferably 5 to 95° C. and the most effectively 60 to 80° C.

When the water-holding material for soil comprising a resin cured product or a water-containing resin cured product to be obtained in the present invention is applied to use of a water-holding material for soil, it is preferable to add (cc) water or (dd) an aqueous solution.

The method for adding (cc) water or (dd) an aqueous solution to the water-holding material for soil comprising a resin cured product of the present invention is not limited. A method comprising, if necessary, pulverizing the above-mentioned resin cured product or water-containing resin cured product into an intended size and performing washing treatment and then mixing a proper amount of (cc) water or (dd) an aqueous solution therein and performing treatment at 20 to 150° C. under a condition of atmospheric pressure or an applied pressure for 1 to 96 hours is exemplified. Thereby, a water-holding material for soil applicable to its object and its use is obtained.

The water content of the water-holding material for soil, which is different depending upon species of (a) an epoxy resin or (b) an amine compound or purposes for use of the water-holding material for soil, is preferably in the range of 2 to 50 times and more preferably in the range of 4 to 30 times the own weight of the above-mentioned re sin cured product or the above-mentioned water-containing resin cured product (excluding containing-water in case of the water-containing resin product). It is possible also to increase or reduce properly the water content in each stage of distribution and preservation.

As methods for applying the water-holding material for soil to be obtained by adding (cc) water or (dd) an aqueous solution to the water-holding material for soil of the present invention to be obtained from a resin cured product and a water-containing resin cured product to soil, it is prefer able to apply a water-holding material for soil mixed (e) a soil in addition to the case of app lying alone there of. In this case, if necessary, it is possible also to mix further (cc) water or (dd) an aqueous solution.

Examples of (e) a soil to be mixed include organic-inorganic soils such as diatomaceous earth, pearlite light weight soil, black soil and red soil, artificial soils such as artificial soil of waste, manure soils such as sludge manure soil and garbage compost soil and one species thereof and a proper mixture of at least two species thereof also can be used.

Particularly, it is preferable to mix 40 to 80% of the water-holding material for soil obtained by adding (cc) water or (dd) an aqueous solution to the water-holding material for soil to be obtained from a resin cured product or a water-containing resin cured product and 20 to 60% of an organic-inorganic soil, an artificial soil to be regenerated from a waste or a manure soil comprising sludge or garbage, whereby it becomes possible to obtain a water-holding material for soil having the most suitable water-holding and water-discharge functions to growth of plants.

According to the present invention, a water-holding material for soil excellent in a balance of water-holding ability and water-discharge ability can be obtained in the range of a water-holding quantity of 2 to 50 times and preferably about 4 to 30 times its own weight.

Generally, as an index representing water-holding and water-discharge characteristics of soil water in agriculture and gardening, a relation between water content percentage and pF value [represented water column height (surface attraction present in an interspace between soil particles) by common logarithm] is used. Conventional soils have a water content percentage of 0 to 80% by weight and a pF value of about 0.3 to 5 (water column height 1×10^{0.3} to 1×10⁵ mm H₂O). The pF value of soil water favorable to growth of plants is about 1 to 3 (water column height 1×10¹ to 1×10³ mm H₂O).

A water-holding material for soil to be obtained by mixing the water-holding material for soil to be obtained by adding (cc) water or (dd) to an aqueous solution to the water-holding material for soil of the present invention to be obtained from a resin cured product or a water-containing resin cured product with (e) a soil in the above-mentioned proportion has a feature excellent in a balance of water-holding ability and water-discharge ability which makes it possible to maintain pF value to about 1 to 3 (water column height 1×10¹ to 1×10³ mm H₂O) corresponding to a level to act on favorable growth of plants in the wide range of water content percentage 10 to 60% by weight. It is suitable to use it as a water-holding material for soil, e.g., in the fields of agriculture and gardening and in the field of desert tree planting.

### BEST MODE FOR CARRYING OUT THE INVENTION

The present invention will be described in more detail below, referring to Examples and Comparative Examples, which are not intended to limit the scope of the present invention. “Part” in Examples represents part by weight, unless it is particularly designated.

The measurement methods of each property in Examples and Comparative Examples are as follows.

[Measurement Method of Water Content Proportion]

Water content proportion was calculated from the following calculation formula

Water content proportion=(W₁−W₀)/W₀

W₀: weight of pulverized product−water content (theoretical value)

W₁: weight of pulverized product after water absorbing treatment

[Measurement Method of pF Value]

The measurement was made with a ceramic soil water meter, manufactured by k.k., Fujiwara Seisakusho (SPDA PF-33 type).

[Measurement Method of Epoxy Equivalent]

(1) Reagent

0.1N acetic acid solution of perchloric acid:

8.5 ml of 72% aqueous solution of perchloric acid, 300 ml of glacial acetic acid and 20 ml of acetic anhydride were charged to 1 L of a flask with scale and sufficiently mixed and then glacial acetic acid was added there to until total amount was reached to 1 L and swing mixed to prepare, and standing over night to use.

An acetic acid solution of tetraethylammonium bromide:

100 g of tetraethylammonium bromide was dissolved in 400 ml of glacial ace tic acid and a few droplet of crystal violet indicator were added thereto.

Crystal violet indicator: 0.1% glacial ace tic acid solution

Potassium hydrogen phthalate: standard reagent

Glacial acetic acid: special grade reagent

(2) Measurement Method

(a) Standardization of 0.1N Acetic Acid Solution of Perchloric Acid

About 0.5 g of potassium hydrogen phthalate was precisely weighed in a triangular flask of 100 ml and 10 ml of glacial acetic acid was added thereto with a pipette to dissolve. Crystal violet indicator was added thereto and titration was performed with 0.1N acetic acid solution of perchloric acid.

(b) Titration of Sample

A sample containing an epoxy group of 0.6 to 0.9 mg equivalent was precisely weighed in a flask of 100 ml and 10 ml of tetraethylammonium bromide solution and 2 to 3 droplets of crystal violet indicator were added thereto and titration was performed with standardized 0.1N acetic acid solution of perchloric acid. Although the color change of the indicator at the end point is very clear, it is preferable to perform potentiometric titration used a glass-calomel electrode. In this case, as a matter of course, standardization of 0.1N acetic acid solution of perchloric acid also is performed by this method.

(3) Calculation Method

Factor (f) of 0.1N acetic acid solution of perchloric acid is represented by the following formula.

f=10000w/204(s−b)

s: ml number of 0.1N acetic solution of perchloric acid needed for titration of potassium hydrogen phthalate.

b: ml number of 0.1N acetic acid solution of perchloric acid needed for blank test in the standardization.

w: ml number of potassium hydrogen phthalate weighed for the standardization.

epoxy equivalent=10000W/f(S−B)

S: ml number of 0.1N acetic acid solution of perchloric acid needed for standardization of a sample.

B: ml number of 0.1N acetic acid solution of perchloric acid needed for blank test in the standardization.

W: ml number of weighed sample

[Calculation of Active Hydrogen Equivalent]

Active hydrogen equivalent was calculated from the following formula.

Active hydrogen equivalent=(molecular weight of amine compound)/(number of hydrogen atom bonded directly to nitrogen atom of amine compound)

### EXAMPLE 1

82 parts of polyethyleneglycol diglycidyl ether (Denacol E X-841, epoxy equivalent: 370 g/e q, manufactured by Nagase Kasei k.k.) and 2 parts of glycerol polyglycidyl ether (Denacol EX-313, epoxy equivalent: 141 g/eq, manufactured by Nagase Kasei k.k.) heated to about 60° C. prior to use were charged to a beaker of 500 ml and 0.1 parts of benzyldimethylamine (BDMA, reagent) as a cure promoter was further added thereto and mixed with stirring. 16 parts of metaxylylenediamine (MXDA, active hydrogen equivalent: 34 g/eq, manufactured by Mitsubishi Gas Chemical Co., Inc.) was added thereto and stirring was further performed. A mixed solution thus obtained was poured into an aluminum mold and heated at 80° C. for one hour in a dryer and then further raised the temperature to heat at 120° C. for one hour, whereby a resin cured product was obtained.

The resin cured product thus obtained was pulverized in a mortar and 5 g of a pulverized product thus obtained was washed with water and then immersed in 100 g of ion-exchanged water of 25° C. to perform water absorbing treatment for 72 hours, whereby a water-holding material for soil was obtained. The water content proportion of the water-holding material for soil was 4.4.

### EXAMPLES 2 TO 10

An epoxy resin, an amine compound and BDMA were mixed in the blending proportion shown in Table 1 according to the same procedure as in Example 1 and heated at a prescribed temperature for a prescribed time, whereby resin cured products were obtained.

Water absorbing treatment for the resin cured products thus obtained was performed in the same manner as in Example 1, whereby water-holding materials for soils were obtained.

Each water content proportion of these water-holding materials for soil was shown in Table 1.

### COMPARATIVE EXAMPLE 1

85 parts of bisphenol A type epoxy resin (Epicoat 828, epoxy equivalent: 189 g/eq, manufactured by Japan Epoxy Resin k.k.), 15 parts of metaxylylenediamine (MXDA) and 0.1 parts of benzyldimethylamine (reagent) were mixed and then a resin cured product was obtained in the same manner as in Example 1.

The resin cured product thus obtained was pulverized in a mortar and 5 g of a pulverized product thus obtained was washed with water and then immersed in 100 g of ion-exchanged water of 25° C. for 72 hours. Water absorbing little occurred.

### EXAMPLE 11

88.3 parts of polyethyleneglycol diglycidyl ether (Denacol EX-861, epoxy equivalent: 551 g/eq, manufactured by Nagase Kasei k.k.) was charged to a beaker of 500 ml and 100 parts of ion-exchanged water was added thereto and mixed at 60° C. with stirring. 11.7 parts of triethylenetetramine (active hydrogen equivalent: 37 g/eq, reagent) was added thereto and stirring was performed for about 5 minutes.

This was heated in a dryer of 80° C. for 2 hours, whereby a water-containing resin cured product (theoretical water content: 100% by weight) was obtained.

Water absorbing treatment for the water-containing resin cured product thus obtained was performed in the same manner as in Example 1, whereby a water-holding material for soil was obtained. The water content proportion of the water-holding material for soil was 12 times.

### EXAMPLES 12 TO 15

A hydrophilic epoxy resin, an amine compound and, BDMA as required were dissolved in ion-exchanged water and mixed in the blending proportion shown in Table 2 according to the same procedure as in Example 11 and heated at a prescribed temperature for a prescribed time, whereby water-containing resin cured products were obtained.

Water absorbing treatment for the water-containing resin cured products thus obtained was performed in the same manner an in Example 1, whereby water-holding materials for soils were obtained.

Each water content proportion of these water-holding materials for soil was shown in Table 2.

### EXAMPLES 16 TO 18

A hydrophilic epoxy resin, an amine compound and, BDMA as required were dissolved and mixed in ion-exchanged water and, a 1.0% by weight dipotassium hydrogenphosphate aqueous solution as required, in the blending proportion shown in Table 2 according to the same procedure as in Example 11 and then heated at a prescribed temperature for a prescribed time, whereby water-holding materials for soil were obtained.

Water absorbing treatment for the water-containing resin cured products thus obtained was performed with ion-exchanged water or a 0.5% by weight urea aqueous solution in the same manner an in Example 1, whereby water-holding materials for soils were obtained.

Each water content proportion of the water-holding materials for soil was shown in Table 2.

### EXAMPLES 19 TO 20

A hydrophilic epoxy resin and an amine compound were mixed with polyacrylic acid soda type hydrophilic resin (Acalic DL-100, manufactured by Nihon Shokubai k.k.) or polyethyleneoxide (Altop MG-150, manufactured by Meisei Kagaku k.k.) and were dissolved and mixed in ion-exchanged water in the blending proportion shown in Table 2 according to the same procedure as in Example 11 and then heated at a prescribed temperature for a prescribed time, whereby water-containing resin cured products were obtained.

Water absorbing treatment for the water-containing resin cured products thus obtained was performed in the same manner as in Example 1, whereby water-holding materials for soil were obtained.

Each water content proportion of the water-holding materials for soil was shown in Table 2.

### COMPARATIVE EXAMPLE 2

90 parts of polyethyleneglycol diglycidyl ether (Denacol EX-861), 10 parts of benzylamine (active hydrogen equivalent: 54 g/eq, reagent) were dissolved and mixed in 100 parts of ion-exchanged water and then heat treated in the same manner as in Example 11. No gelation occurred.

### EXAMPLE 21

100 g of the water-holding material for soil obtained in Example 18, 40 g of a cultivated soil obtained on market and 10 g of water were mixed in a beaker of 200 ml and standing in the atmosphere of temperature 28° C. and humidity 50% for 10 days. The weight and pF value were measured. The pF value was maintained to 0.8 to 2.8 until 9th day when the water content percentage reached from 66% to about 10% and the period maintained the water state effective for a plant was 9 days (Table 3).

### COMPARATIVE EXAMPLE 3

The experiment was performed in the same manner as in Example 21 except that 100 g of a material containing 1 g of polyacrylic acid soda type hydrophilic resin (Acalic DL-100) in 99 g of ion-exchanged water was used instead of 100 g of the water-holding material for soil. The weight and pF value were measured. The pF value reached to about 1.0 for the first time on the 9 th day when the water content percentage reached to 30%, and it reached to 2.8 on the 10 th day. Thus, the period maintained the water state effective for a plant was about 2 to 3 days (Table 3).

### EXAMPLE 22

The growth test for ten samples of a violet was conducted using a water-holding material for soil mixed the water-holding material for soil obtained in Example 18 and a cultivated soil obtained on market in the blending portion of 6/4. They are standing in the atmosphere of 26° C. and humidity 50% for 10 days without providing water. Favorable growth of the violet occurred in all of the ten samples.

### COMPARATIVE EXAMPLE 4

The growth test for ten samples of a violet was conducted in the same manner as in Example 22 except that a material containing 1 g of polyacrylic acid sod a type hydrophilic resin (Acalic DL-100) in 99 g of ion exchanged water was used instead of the water-holding material for soil obtained in Example 18. In eight samples among the ten samples, root decay of the violet occurred.

### INDUSTRIAL APPLICABILITY

Each water content of the water-holding material for soil to be obtained from a resin cured product and a water-containing resin cured product according to the present invention and a water-holding material for soil obtained by adding water or an aqueous solution to the above-mentioned water-holding materials for soil is 50 times each its own weight or below and has smaller water-holding ability than conventional water-holding materials for soil. However, on the other hand, they are good in a balance of water-holding ability and water-discharge ability. A water-holding materials for soil mixed these water-holding materials for soil with a soil has a characteristic capable of maintaining a level of pF value to act on favorable growth of a plant in the wide range of water content proportion and are suitable to use as a water-holding material for soil, e.g., in the fields such as agriculture and gardening and its industrial practicability is very high.

TABLE 1

| | Example 1 | Example 2 | Example 3 | Example 4 | Example 5 | Example 6 | Example 7 | Example 8 | Example 9 | Example 10 | Comp. Ex. 1 |
|---|---|---|---|---|---|---|---|---|---|---|---|
| [Epoxy] | | | | | | | | | | | |
| Ex-841 | 82.0 | | | | 92.0 | | | | | | |
| Ex-861 | | 89.0 | 91.5 | 95.0 | | 88.6 | 86.0 | 91.5 | 88.3 | 92.0 | |
| Ex-920 | | | | | | | 8.0 | | | | |
| Ex-313 | 2.0 | | | | | | | | | | |
| Ex-421 | | | | | | | | | | 3.0 | |
| Epicoat 828 | | | | | | | | | | | 85.0 |
| [Amine | | | | | | | | | | | |
| compound] | | | | | | | | | | | |
| MXDA | 16.0 | 11.0 | 8.5 | 5.0 | | | | | | | 15.0 |
| HMDA | | | | | 8.0 | | | | | | |
| 1,3-BAC | | | | | | 11.4 | | | | | |
| IPDA | | | | | | | 6.0 | | | | |
| DETA | | | | | | | | 8.5 | | | |
| TETA | | | | | | | | | 11.7 | | |
| mPDA | | | | | | | | | | 5.0 | |
| BDMA | 0.1 | 0.1 | 0.1 | 0.1 | 0.1 | 1.0 | 1.0 | 0.1 | 0.1 | 0.1 | 0.1 |
| Heat curing | 1 h/ | 1 h/ | 1 h/ | 1 h/ | 1 h/ | 1 h/ | 1 h/ | 1 h/ | 1 h/ | 1 h/ | 1 h/ |
| condition | 80° C. + | 80° C. + | 80° C. + | 80° C. + | 80° C. + | 80° C. + | 80° C. + | 80° C. + | 80° C. + | 80° C. + | 80° C. + |
| | 1 h/ | 1 h/ | 1 h/ | 1 h/ | 1 h/ | 1 h/ | 1 h/ | 1 h/ | 1 h/ | 1 h/ | 1 h/ |
| | 120° C. | 120° C. | 120° C. | 120° C. | 120° C. | 120° C. | 120° C. | 120° C. | 120° C. | 120° C. | 120° C. |
| Water | 4.4 | 10.0 | 4.4 | 8.0 | 3.9 | 9.2 | 5.1 | 7.6 | 6.8 | 4.2 | <0.1 |
| content | | | | | | | | | | | |
| proportion | | | | | | | | | | | |
| (times) | | | | | | | | | | | |

Note:
EX-841 (epoxy equival. 370 g/eq),
EX-861(epoxy equival. 551/eq): polyethyleneglycol diglycidyl ether,
EX-920 (epoxy equival. 176 g/eq): polypropylene glycol diglycidyl ether,
EX-313(epoxy equival. 141/eq): glycerol polyglycidyl ether and
EX-421(epoxy equival. 159/eq): diglycerol polyglycidyl ether, produed by Nagase Kasei k.k.
Epicoat 828 (epoxy equival. 189 g/eq): bisphenol A type epoxy, produed by Japan Epoxy Resin k.k.
MXDA (active hydrogen equival. 34 g/eq): metaxylylenediamine and
1,3-BAC (active hydrogen equival. 36 g/eq): 1,3-bisaminomethylcyclohexane, produced by Mitsubishi Gas Chemical Co, Inc.
HMDA (active hydrogen equival. 29 g/eq): hexamethylenediamine,
IPDA (active hydrogen equival. 43 g/eq): isophoronediamine,
DETA (active hydrogen equival. 26 g/eq): diethylenetriamine,
TETA (active hydrogen equival. 37 g/eq): triethylenetetramine,
mPDA (active hydrogen equival 27 g/eq): metaphenylenediamine and
BDMA: benzyldimethylamine are reagents

TABLE 2

| | Example | Example | Example | Example | Example | Example | Example | Example | Example | Example | |
|---|---|---|---|---|---|---|---|---|---|---|---|
| | 11 | 12 | 13 | 14 | 15 | 16 | 17 | 18 | 19 | 20 | Comp. Ex. 2 |
| [Epoxy ] | | | | | | | | | | | |
| Ex-841 | | | 94.0 | | | | | | | | |
| Ex-861 | 88.3 | 88.3 | | 91.3 | 60.0 | | 30.0 | 94.0 | 84.5 | 84.5 | 90.0 |
| Ex-920 | | | | | | 30.0 | | | | | |
| Ex-421 | | | | | | | 10.0 | | | | |
| [Amine | | | | | | | | | | | |
| compound] | | | | | | | | | | | |
| MXDA | | | | | | | | 4.0 | 15.5 | 15.5 | |
| ED2003 | | | | | 40.0 | 70.0 | 60.0 | | | | |
| HMDA | | | | | | | | 2.0 | | | |
| 1,3-BAC | | | 6.0 | | | | | | | | |
| DETA | | | | 8.7 | | | | | | | |
| TETA | 11.7 | 11.7 | | | | | | | | | |
| Benzylamine | | | | | | | | | | | 10.0 |
| DL-100 | | | | | | | | | 10 | | |
| MG-150 | | | | | | | | | | 10 | |
| BDMA | | | 0.2 | | 0.2 | 0.2 | 0.2 | | | | |
| 1% PDP*¹ | | | | | | 50 | | 20 | | | |
| Ion Exch.*² | 100 | 200 | 300 | 100 | 100 | 50 | 50 | 80 | 90 | 90 | 100 |
| Heat curing | 2 h/ | 2 h/ | 2 h/ | 2 h/ | 2 h/ | 2 h/ | 2 h/ | 2 h/ | 2 h/ | 2 h/ | 2 h/ |
| condition | 80° C. | 80° C. + | 80° C. + | 80° C. | 80° C. + | 80° C. + | 80° C. + | 80° C. | 80° C. | 80° C. | 80° C. |
| | | 1 h | 3 h | | 3 h | 2 h | 2 h | | | | |
| | | 90° C. | 90° C. | | 90° C. | 90° C. | 90° C. | | | | |
| TWC*³ (wt %) | 100 | 200 | 300 | 100 | 200 | 99.5 | 50 | 99.8 | 81.8 | 81.8 | 100 |
| [Water | | | | | | | | | | | |
| absorbing | | | | | | | | | | | |
| treatment] | | | | | | | | | | | |
| 0.5% Urea*⁴ | | | | | | | 100 g | 100 g | | | |
| Ion Exch.*² | 100 g | 100 g | 100 g | 100 g | 100 g | 100 g | | | 100 g | 100 g | |
| Water | 12 | 15 | 9 | 20 | 24 | 8 | 5 | 6 | 11 | 9 | non-cured |
| content | | | | | | | | | | | |
| proportion | | | | | | | | | | | |
| (times) | | | | | | | | | | | |

Note:
*¹1% potassium dihydrogenphsophate aqueous solution,
*²Ion exchanged water,
*³Theoretical water content,
*⁴0.5% urea aqueous solution
ED2003(hyrogen active equival. 500 g/eq): polyetheramine, produced by US Hantzman Co., Benzylamine(hyrogen active equival. 54 g/eq) reagent
Acaric DL-150: polyacrylic acid soda type hydrophilic resin, produced by Nihon Shokubai k.k.
Altop MG-150: polyethylenoxide, produced by Meiwa Kagaku k.k.

TABLE 3

| | |
|---|---|
| Example 21 | Comp. Ex. 3 |

| | | | | |
|---|---|---|---|---|
| Blending | Water-holding material for | 100 g | Polyacrlyric acid soda type | 100 g |
| composition | soil (Example 18) | | hydrophilic resin | |
| | (water content proportion 7.3) | | (water content proportion 99) | |
| | Cultivated soil | 40 g | Cultivated soil | 40 g |
| | Water | 10 g | Water | 10 g |

| | | Water | | | Water | |
|---|---|---|---|---|---|---|
| | Weight(g) | content(wt %) | PF value | Weight(g) | content(wt %) | PF value |
| Start | 150 | 66 | 0.8 | 150 | 73 | 0.2 |
| 1st day | 139 | 63 | 0.9 | 139 | 71 | 0.2 |
| 2nd day | 128 | 60 | 1.0 | 127 | 68 | 0.3 |
| 3rd day | 118 | 56 | 1.0 | 117 | 65 | 0.3 |
| 4th day | 108 | 52 | 1.2 | 106 | 61 | 0.3 |
| 5th day | 97 | 46 | 1.2 | 96 | 57 | 0.4 |
| 6th day | 88 | 41 | 1.5 | 86 | 52 | 0.4 |
| 7th day | 79 | 34 | 1.8 | 76 | 46 | 0.5 |
| 8th day | 68 | 24 | 2.0 | 67 | 39 | 0.6 |
| 9th day | 59 | 12 | 2.8 | 57 | 28 | 1.3 |
| 10th day | 54 | 4 | >4 | 47 | 13 | 2.8 |

1. A water-holding material for soil obtained by curing a composition comprising (a) a hydrophilic epoxy resin having at least two epoxy resin groups per one molecule and (b) an amine compound having at least two primary or secondary amino groups per one molecule as indispensable components.

2. The water-holding material for soil according to claim 1, wherein a ratio of said (b) amine compound to said (a) epoxy resin is in the range of 0.3/1 to 3/1 in an equivalent ratio of hydrogen atom bonded directly to nitrogen atom of (b) an amine compound to epoxy group of (a) an epoxy resin.

3. A water-holding material for soil obtained by mixing a composition comprising (a) a hydrophilic epoxy resin having at least two epoxy resin groups per one molecule and (b) an amine compound having at least two primary or secondary amino groups per one molecule as indispensable components with (c) water or (d) an aqueous solution and performing cure in a water-containing state.

4. The water-holding material for soil according to claim 3, wherein a ratio of said (b) amine compound to said (a) epoxy resin is in the range of 0.3/1 to 3/1 in an equivalent ratio of hydrogen atom bonded directly to nitrogen atom of (b) an amine compound to epoxy group of (a) an epoxy resin.

5. The water-holding material for soil according to claim 3 or claim 4, wherein an amount of said (c) water or said (d) aqueous solution is in the range of 1 to 500 parts by weight per 100 parts by weight of said composition.

6. The water-holding material for soil according to any one of claims 1 to 5, wherein said (a) epoxy resin is a polyether type epoxy resin, a polyhydric alcohol type epoxy resin or a mixture thereof.

7. The water-holding material for soil according to any one of claims 1 to 6, wherein said (b) amine compound is aliphatic primary amines, alicyclic primary amines or a mixture thereof.

8. The water-holding material for soil according to claim 6, wherein said (a) epoxy resin is at least one compound selected from the group consisting of polyethyleneglycol diglycidyl ether, polypropylene-glycol diglycidyl ether, glycerol polyglycidyl ether and polyglycerol polyglycidyl ether.

9. The water-holding material for soil according to claim 7, wherein said (b) amine compound is at least one compound selected from the group consisting of polyethylenediamine, polyetherdiamine, xylylendiamine, bisaminomethylcyclohexane and isophoronediamine.

10. A water-holding material for soil obtained by wash-treating with water the water-holding material for soil described in any one of claims 1 to 9.

11. A water-holding material for soil obtained by adding further (cc) water or (dd) an aqueous solution to the water-holding material for soil described in any one of claims 1 to 10.

12. A water-holding material for soil obtained by mixing the water-holding material for soil described in any one of claims 1 to 11 with (e) a soil.

13. A method for holding water in a soil which comprises mixing the water-holding material for soil described in any one of claims 1 to 11 with (e) a soil to use.
